(19) United States
(12) Patent Application Publication
(10) Pub. No.: US 2026/0300349 A1
(43) Pub. Date: Oct. 1, 2026

(54) TEXT ATTRIBUTION VIA SIMILARITY ASSESSMENT

(71) Applicant: International Business Machines Corporation, Armonk, NY (US)

(72) Inventors: Anna Lisa Gentile, San Jose, CA (US); Chad Eric DeLuca, Morgan Hill, CA (US)

(21) Appl. No.: 19/089,150

(22) Filed: Mar. 25, 2025

(51) Int. Cl. G06F 16/334; G06F 16/338

(52) U.S. Cl. CPC G06F 16/3347; G06F 16/338

(57) ABSTRACT

A system includes a processor that executes computer executable components stored in a memory. The computer executable components can comprise an indexing component that generates and stores a first text representation and a first vector representation of a reference document. The computer executable components can further comprise a query processing component that generates a second text representation and a second vector representation of a query pertaining to a designated target content. The computer executable components can further comprise a matching component that the second text representation and the second vector representation of the query against the first text representation and the first vector representation of the reference dataset using vector-based filtering and applies text-based similarity scoring to identify potential attribution against the designated target content.

### TECHNICAL FIELD

The subject disclosure relates to text attribution via similarity assessment, e.g., techniques for identifying or analyzing textual similarities to determine authorship, originality, or potential content reuse.

### BACKGROUND

Large language models (LLMs) can generate text based on trained datasets, enabling a wide range of applications, including content creation, summarization, translation, or automated assistance. As these models become increasingly integrated into various industries, concerns have arisen regarding the potential for a large language model to produce text that incorporates proprietary content, copyrighted material, confidential information, and other protected data without proper attribution.

As organizations increasingly integrate large language models (LLMs) into their workflows, there is an increasing need for a mechanism to verify originality and attribution of generated content. Without effective safeguards, companies and individuals can risk exposure to legal, ethical, or security issues.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate identification, attribution, or filtering of generated content to detect proprietary, copyrighted, or confidential material using vector-based and text-based similarity analysis are provided.

According to an embodiment, a system can comprise a processor that executes computer executable components stored in memory. The computer executable components can comprise an indexing component that generates and stores a first text representation and a first vector representation of a reference document. The computer executable components can further comprise a query processing component that generates a second text representation and a second vector representation of a query pertaining to a designated target content. The computer executable components can further comprise a matching component that matches the second text representation and the second vector representation of the query against the first text representation and the first vector representation of the reference dataset using vector-based filtering and applies text-based similarity scoring to identify potential attribution against the designated target content.

According to another embodiment, a computer-implemented method can comprise generating and storing, by a system operatively coupled to a processor, a first text representation and a first vector representation of a reference document. The computer-implemented method comprises generating, by a system, a second text representation and a second vector representation of a query pertaining to a designated target content. The computer-implemented method comprises matching, by a system, the second text representation and the second vector representation of the query against the first text representation and the first vector representation of the reference dataset using vector-based filtering. The computer-implemented method comprises applying, by a system, text-based similarity scoring to identify potential attribution against the designated target content.

According to another embodiment, a computer program product comprising a computer readable storage medium having program instructions embodied therewith, the program instructions executable by a processor to cause the processor to generate and store, by the processor, a first text representation and a first vector representation of a reference document. The program instructions can also cause the processor to generate, by the processor, a second text representation and a second vector representation of a query pertaining to a designated target content. The program instructions can also cause the processor to match, by the processor, the second text representation and the second vector representation of the query against the first text representation and the first vector representation of the reference dataset using vector-based filtering and applies text-based similarity scoring to identify potential attribution against the designated target content.

### BRIEF DESCRIPTION OF THE DRAWINGS

FIGS. 1 and 2 illustrate example systems that can facilitate text attribution via similarity assessment in accordance with some embodiments described herein.

FIGS. 3, 4A, 4B, and 4C illustrate flow diagrams of example computer implemented methods that can facilitate text attribution via similarity assessment in accordance with some embodiments described herein.

FIG. 5 illustrates an example overview of an indexed reference dataset and similarity assessment process, which facilitates efficient and scalable content attribution in accordance with some of the embodiments described herein.

FIG. 6 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

The advent of large language models (LLMs) has introduced numerous technological advancements, enabling automation, content generation, and natural language understanding across various domains. However, these advancements have also raised concerns among private users, businesses, or regulatory bodies regarding potential risks associated with their deployment. One significant challenge pertains to inadvertent incorporation or disclosure of proprietary content, which can lead to copyright infringement, confidentiality breaches, or unauthorized dissemination of sensitive information.

These issues can arise at multiple levels. On a model training side, of large language models (LLMs) can generate outputs based on vast datasets, which may inadvertently include proprietary or copyrighted material if such content was used in training. On a user interaction side, individuals interacting with large language models (LLMs) can unintentionally disclose proprietary or sensitive information through their prompts, leading to potential security or intellectual property risks.

Existing content attribution or similarity detection techniques primarily rely on methods such as keyword matching, string-based comparison, or heuristic-based similarity scoring. While these approaches can identify exact text matches, they often fail to detect reworded, paraphrased, or contextually modified content, which can be crucial when assessing potential misuse of proprietary information. Additionally, traditional techniques may struggle with scalability, efficiency, or accuracy, especially when handling large volumes of text or complex linguistic transformations.

To address these challenges, the disclosed invention provides systems, computer-implemented methods, and computer program products that can screen or evaluate textual content using advanced retrieval and similarity assessment techniques. The system can utilize vector-based filtering, text-based similarity scoring, or adaptive attribution mechanisms to identify potential attribution against any designated reference content. By combining multiple layers of analysis, the system can detect exact matches, near matches, or reworded variations of content, providing a more comprehensive and adaptable solution for content attribution.

The innovations disclosed herein can significantly enhance accuracy, efficiency, or scalability in identifying proprietary content. By implementing adaptive similarity scoring techniques, the system can distinguish between different levels of similarity, ensuring that content attribution can be precise and flexible depending on a use case. Additionally, by leveraging a vector-based representation and contextual weighting, the system can improve text retrieval and similarity analysis.

Embodiments of the disclosed invention can apply to various industries, enabling content attribution, copyright protection, confidential data screening, or compliance monitoring. It can be used to detect unauthorized reuse of proprietary content, ensure compliance with data privacy laws, or identify trademarked or proprietary language. Additionally, it can support academic integrity, fraud detection, or cybersecurity by preventing the misuse or unauthorized disclosure of sensitive information.

In relation to text attribution via similarity assessment, embodiments disclosed herein produce a solution to one or more of these problems. These embodiments can solve such problems by generating and storing a first text representation and a first vector representation of a reference document; by generating a second text representation and a second vector representation of a query pertaining to a designated target content; by matching, the second text representation and the second vector representation of the query against the first text representation and the first vector representation of the reference dataset using vector-based filtering; by applying text-based similarity scoring to identify potential attribution against the designated target content.

According to an embodiment, a system can include a processor that executes computer executable components stored in a memory. The computer executable components can include an indexing component that generates and stores a first text representation and a first vector representation of a reference document. The computer executable components can further include a query processing component that generates a second text representation and a second vector representation of a query pertaining to a designated target content. The computer executable components can further include a matching component that matches the second text representation and the second vector representation of the query against the first text representation and the first vector representation of the reference dataset using vector-based filtering and applies text-based similarity scoring to identify potential attribution against the designated target content.

In some embodiments, the system can further comprise a segmentation component that generates a shingle from a query text at runtime, wherein a shingle configuration is determined based on a use case and a text length.

The indexing component can enable efficient retrieval and comparison by maintaining a structured representation of stored content. By converting textual data into both text-based and vector-based formats, the indexing component can allow for multiple levels of similarity assessment, improving accuracy in content attribution. In some embodiments, the indexing component can store the first text representation and the first vector representation together in a structured index to improve retrieval efficiency.

The query processing component can ensure that query inputs are processed in a manner consistent with a stored reference dataset, enabling effective comparison. By transforming queries into structured representations, the query processing component can allow for both exact and approximate matching against reference data. In some embodiments, the query processing component can generate the second vector representation of a query text using at least one of: machine learning model, a neural network, or an embedding-based method. These techniques convert textual data into a numerical format that can capture semantic meaning and contextual relationships between words, rather than relying on exact word matches. In various embodiments, the query processing component can generate a variable-length text representation of the second text representation and a fixed-length vector representation of the second vector representation based on runtime properties of a query text. By dynamically adapting the second text representation and the second vector representation at runtime, the system can ensure greater accuracy, flexibility, or efficiency in content attribution, even for queries of varying complexity.

The matching component can perform vector-based filtering to compare the first text representation against the second text representation and the first vector representation against the second vector representation. After filtering, the matching component can apply text-based similarity scoring to refine attribution assessment, enabling detection of exact matches, near-exact matches, or reworded content. This dual-layer approach can ensure that proprietary, copyrighted, or confidential content can be accurately identified even when rephrased or modified.

In some embodiments, the matching component can apply an adjustable similarity threshold to determine whether a match is exact, near exact, or reworded. This threshold can be adjustable, allowing the system to be fine-tuned based on the desired level of similarity sensitivity.

According to some embodiments, the matching component can combine shingles of variable lengths with indexed text to improve accuracy of similarity detection. The matching component can enhance similarity detection by employing shingling, a technique that breaks text into overlapping fragments of varying lengths, allowing the system to detect both exact phrase matches and paraphrased segments more effectively by aligning these shingles with indexed reference text for improved accuracy and efficiency in attribution assessment.

In various embodiments, the matching component can apply a runtime-adjustable strictness parameter that allows variations in word order and text structure. The adjustable strictness can provide a customizable approach to similarity detection, making the system adaptable to various attribution and compliance requirements.

In some embodiments, the matching component can perform the vector-based filtering before applying the text-based similarity scoring. This two-step approach can reduce computational overhead.

According to various embodiments, the matching component can incorporate context-aware analysis by weighting different portions of the first text representation and the second text representation and the first vector representation and the second vector representation based on semantic importance. By prioritizing semantically important text, the system can enhance precision in identifying meaningful matches while reducing false positives from insignificant similarities.

Advantages of this system can include improved accuracy in content attribution, enhanced detection of reworded proprietary material, or increased efficiency in text similarity assessment.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

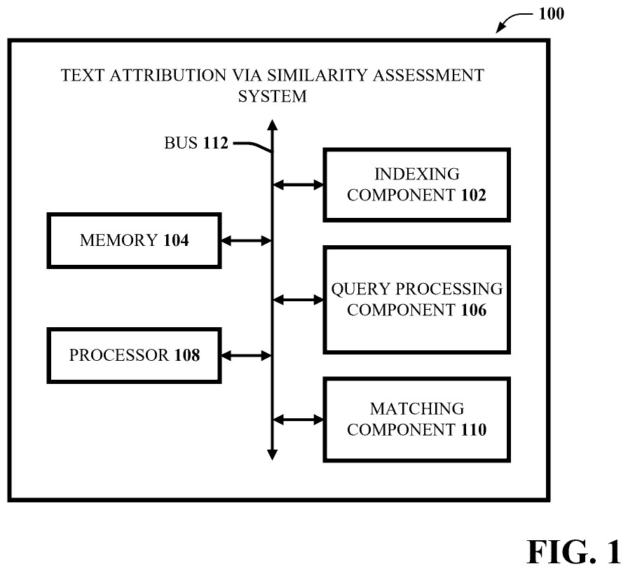

FIG. 1 illustrates an example system 100 for facilitating text attribution via similarity assessment. System 100 uses an indexing component, a query processing component, and a matching component. The indexing component generates and stores a first text representation and a first vector representation of a reference document. The query processing component generates a second text representation and a second vector representation of a query pertaining to a designated target content. The matching component matches the second text representation and the second vector representation of the query against the first text representation and the first vector representation of the reference dataset using vector-based filtering and applies text-based similarity scoring to identify potential attribution against the designated target content.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise an indexing component 102, a memory 104, a query processing component 106, a processor 108, a matching component 110, and a system bus 112.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to text attribution and similarity assessment by enhancing accuracy, efficiency, or scalability of content comparison using various techniques, which can include filtering, similarity scoring, adaptive thresholding, or context-aware analysis, among others.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the indexing component 102, the query processing component 106, and/or the matching component 110) to perform one or more actions. In some embodiments, the memory 104 can store computer-executable components (e.g., the indexing component 102, the query processing component 106, and/or the matching component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writeable, and/or executable components and/or instructions. When executed by the processor 108, these components and/or instructions can enable performance of one or more operations defined by the component(s) and/or instruction(s).

In various embodiments, the indexing component 102 generates and stores a first text representation and a first vector representation of a reference document. In some embodiments, the indexing component 102 can store the first text representation and the first vector representation together in a structured index to improve retrieval efficiency.

According to some embodiments, the query processing component 106 generates a second text representation and a second vector representation of a query pertaining to a designated target content. In some embodiments, the query processing component 106 can generate the second vector representation of a query text using at least one of: machine learning model, a neural network, or an embedding-based method. These techniques convert textual data into a numerical format that can capture semantic meaning and contextual relationships between words, rather than relying on exact word matches. In various embodiments, the query processing component 106 can generate a variable-length text representation of the second text representation and a fixed-length vector representation of the second vector representation based on runtime properties of a query text. By dynamically adapting the second text representation and the second vector representation at runtime, the system can ensure greater accuracy, flexibility, or efficiency in content attribution, even for queries of varying complexity.

In various embodiments, the matching component 110 can match the second text representation and the second vector representation of the query against the first text representation and the first vector representation of the reference dataset using vector-based filtering and applies text-based similarity scoring to identify potential attribution against the designated target content. In some embodiments, the matching component 110 can apply an adjustable similarity threshold to determine whether a match is exact, near exact, or reworded. This threshold can be adjustable, allowing the system to be fine-tuned based on the desired level of similarity sensitivity. According to some embodiments, the matching component 110 can combine shingles of variable lengths with indexed text to improve accuracy of similarity detection. The matching component 110 can enhance similarity detection by employing shingling, a technique that breaks text into overlapping fragments of varying lengths, allowing the system to detect both exact phrase matches and paraphrased segments more effectively by aligning these shingles with indexed reference text for improved accuracy and efficiency in attribution assessment. In various embodiments, the matching component 110 can apply a runtime-adjustable strictness parameter that allows variations in word order and text structure. The adjustable strictness can provide a customizable approach to similarity detection, making the system adaptable to various attribution and compliance requirements. In some embodiments, the matching component 110 can perform the vector-based filtering before applying the text-based similarity scoring. This two-step approach can reduce computational overhead. According to various embodiments, the matching component 110 can incorporate context-aware analysis by weighting different portions of the first text representation and the second text representation and the first vector representation and the second vector representation based on semantic importance. By prioritizing semantically important text, the system can enhance precision in identifying meaningful matches while reducing false positives from insignificant similarities.

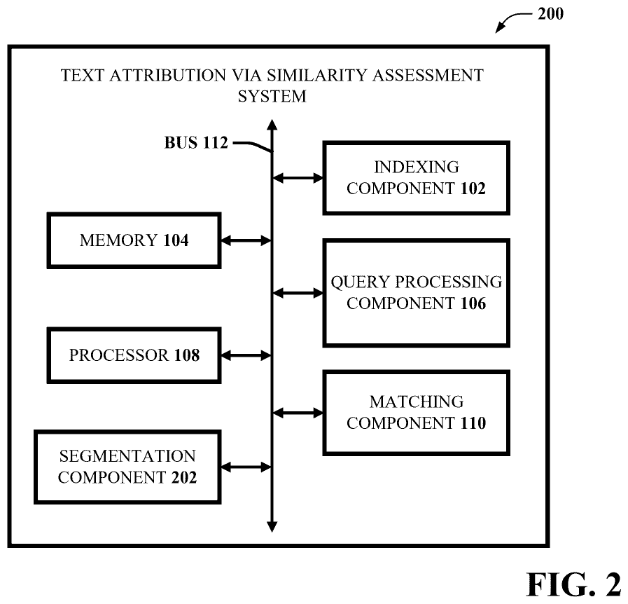

FIG. 2 illustrates an example system 200 that can facilitate text attribution via similarity assessment. System 200 uses indexing component 102, query processing component 106, matching component 110 and segmentation component 202. The indexing component 102 generates and stores a first text representation and a first vector representation of a reference document. The query processing component 106 generates a second text representation and a second vector representation of a query pertaining to a designated target content. The matching component 110 matches the second text representation and the second vector representation of the query against the first text representation and the first vector representation of the reference dataset using vector-based filtering and applies text-based similarity scoring to identify potential attribution against the designated target content. Description of like components has been omitted for the sake of brevity.

In various embodiments, the system can further comprise a segmentation component 202 that that generates a shingle from a query text at runtime, wherein a shingle configuration is determined based on a use case and a text length. The segmentation component 202 can enable dynamic and adaptive shingle generation, allowing the system to avoid static, predefined segmentation constraints. The system can adjust shingle length based on contextual factors, optimizing similarity detection accuracy across varied text structures or content lengths. This approach can enhance the system's ability to capture both exact and paraphrased matches, improving the precision of text attribution assessments.

In some embodiments, the segmentation component 202 can interact with other components to refine text-based similarity scoring by aligning shingles with indexed reference data. Additionally, by generating shingles dynamically, the system can improve computational efficiency, reducing unnecessary comparisons while preserving high recall accuracy in similarity assessments.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

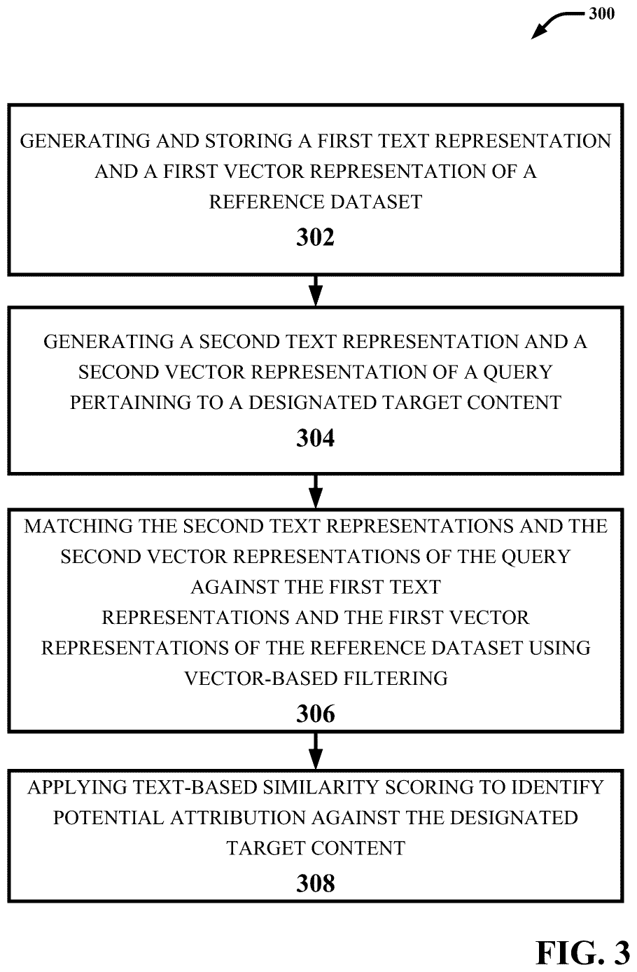

Next, FIG. 3 illustrates a flow diagram of a method 300 that can facilitate text attribution via similarity assessment in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes generating and storing a first text representation and a first vector representation of a reference document. The method 300 can use a system operatively coupled to the processor (e.g., indexing component 102) to generate and store a first text representation and a first vector representation of a reference document.

At 304, method 300 includes generating a second text representation and a second vector representation of a query pertaining to a designated target content. The method 300 can use a system operatively coupled to the processor (e.g., query processing component 106) to generate a second text representation and a second vector representation of a query pertaining to a designated target content.

At 306, method 300 includes matching the second text representation and the second vector representation of the query against the first text representation and the first vector representation of the reference dataset using vector-based filtering. The method 300 can use a system operatively coupled to the processor (e.g., matching component 110) to match the second text representation and the second vector representation of the query against the first text representation and the first vector representation of the reference dataset using vector-based filtering.

At 308, method 300 includes applying text-based similarity scoring to identify potential attribution against the designated target content. The method 300 can use a system operatively coupled to the processor (e.g., matching component 110) to apply text-based similarity scoring to identify potential attribution against the designated target content.

In some embodiments, method 300 is performed by a system, such as system 100 of FIG. 1 or system 200 of FIG. 2. The generating and storing a first text representation and a first vector representation of a reference dataset 302 can be performed by an indexing component (e.g., indexing component 102 of FIG. 2). The generating a second text representation and a second vector representation of a query pertaining to a designated target content 304 can be performed by a query processing component (e.g., query processing component 106). The matching the second text representation and the second vector representation of the query against the first text representation and the first vector representation of the reference dataset using vector-based filtering 306 can be performed by a matching component (e.g., matching component 110). The applying text-based similarity scoring to identify potential attribution against the designated target content 308 can be performed by a matching component (e.g., matching component 110).

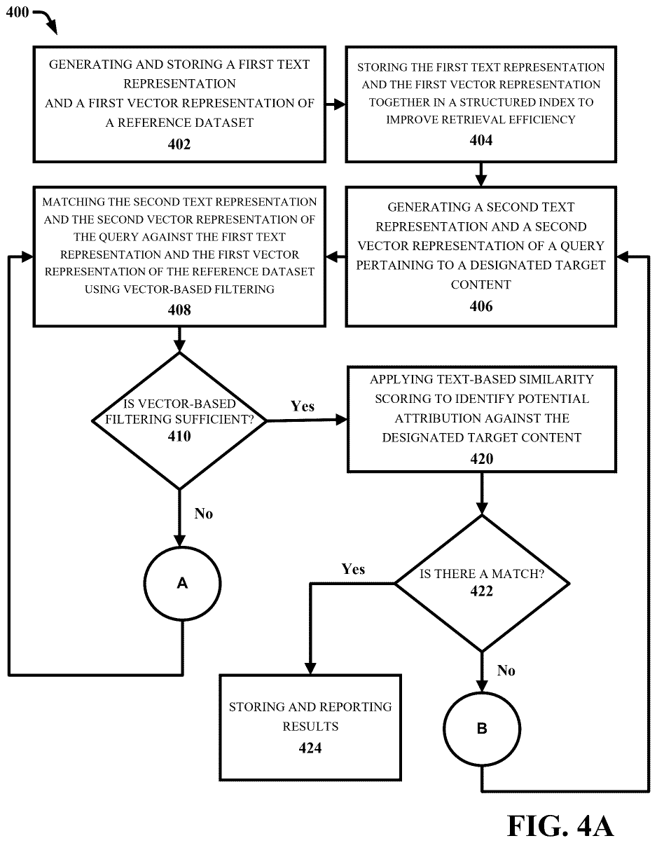

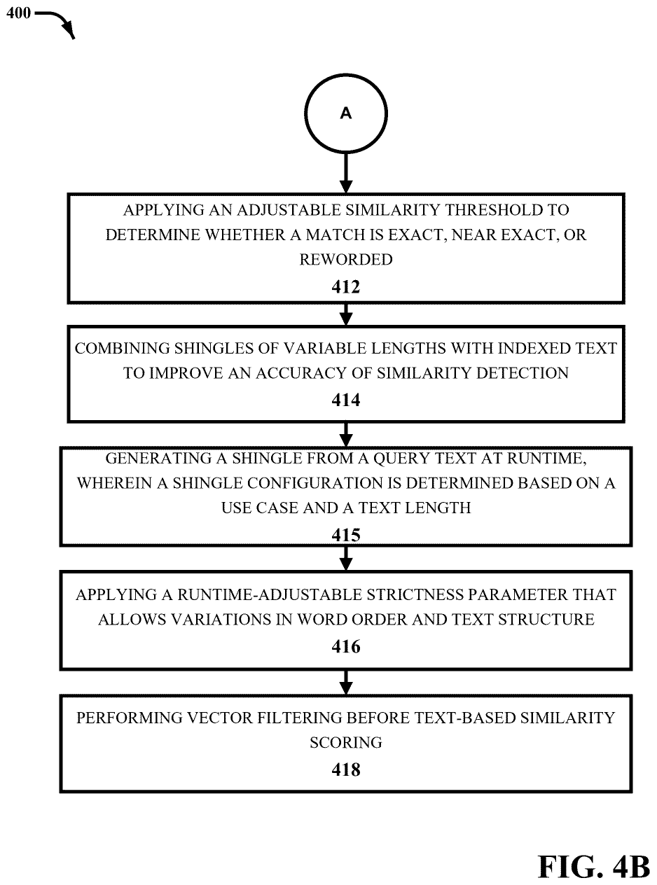

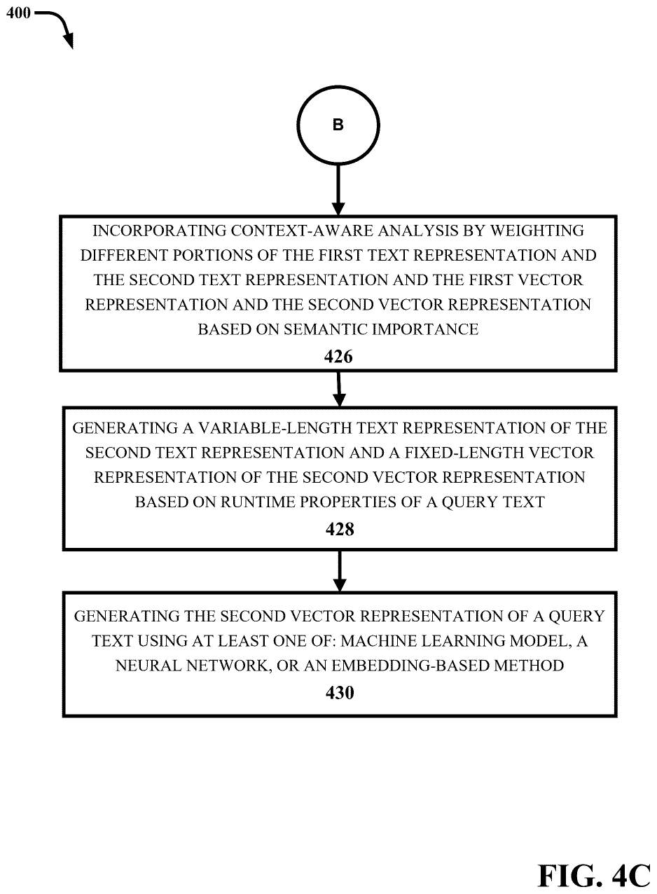

Next, FIG. 4A illustrates a flow diagram of a method 400 that can facilitate text attribution via similarity assessment in accordance with some embodiments described herein. While the method 400 is described relative to the system 200 of FIG. 2, the method 400 can be applicable also to other systems described herein, such as the system 100 of FIG. 1.

At 402, method 400 includes generating and storing a first text representation and a first vector representation of a reference document. The method 400 can use a system operatively coupled to the processor (e.g., indexing component 102) to generate and store a first text representation and a first vector representation of a reference dataset for subsequent retrieval.

At 404, method 400 includes storing the first text representation and the first vector representation together in a structured index to improve retrieval efficiency. The method 400 can use a system operatively coupled to the processor (e.g., indexing component 102) to store the first text representation and the first vector representation together in a structured index to improve retrieval efficiency.

At 406, method 400 includes generating a second text representation and a second vector representation of a query pertaining to a designated target content. The method 400 can use a system operatively coupled to the processor (e.g., query processing component 106) to generate a second text representation and a second vector representation of a query pertaining to a designated target content.

At 408, method 400 includes matching the second text representation and the second vector representation of the query against the first text representation and the first vector representation of the reference dataset using vector-based filtering. The method 400 can use a system operatively coupled to the processor (e.g., matching component 110) to match the second text representation and the second vector representation of the query against the first text representation and the first vector representation of the reference dataset using vector-based filtering.

At 410, method 400 includes determining whether vector-based filtering is sufficient to establish a match. The method 400 can use a system operatively coupled to a processor (e.g., query processing component 106, matching component 110) to evaluate the filtering results. If the vector-based filtering is determined to be sufficient, the method proceeds to step 420 Otherwise, the method transitions to a subprocess detailed in FIG. 4B, denoted by “A.”

At 420, method 400 includes applying text-based similarity scoring to refine the attribution assessment. The method 400 can use a system operatively coupled to a processor (e.g., matching component 110) to compute a similarity score based on textual features and determine whether the query content corresponds to the reference dataset.

At 422, method 400 includes determining whether the similarity score indicates a match. The method 400 can use a system operatively coupled to a processor (e.g., matching component 110) to compare the similarity score to a predefined threshold. If a match is identified, the method proceeds to step 424, where the results are stored and reported. Otherwise, the method transitions to a subprocess detailed in FIG. 4C, denoted by “B.”

At 424, method 400 includes storing and reporting the results of the attribution analysis. The method 400 can use a system operatively coupled to a processor to store the matching data and generate a report based on the detected similarity.

One or more systems, devices, computer program products, and/or computer-implemented methods provided herein relate to text attribution via similarity assessment. A system can include a processor that executes computer executable components stored in memory. The computer executable components can include an indexing component that generates and stores a first text representation and a first vector representation of a reference document. The computer executable components can further include a query processing component that generates a second text representation and a second vector representation of a query pertaining to a designated target content. The computer executable components can further include a matching component that matches the second text representation and the second vector representation of the query against the first text representation and the first vector representation of the reference dataset using vector-based filtering and applies text-based similarity scoring to identify potential attribution against the designated target content.

Advantages of this system can include improved accuracy in content attribution, enhanced detection of reworded proprietary material, or increased efficiency in text similarity assessment.

In various embodiments, the indexing component generates and stores a first text representation and a first vector representation of a reference document. In some embodiments, the indexing component can store the first text representation and the first vector representation together in a structured index to improve retrieval efficiency.

According to some embodiments, the query processing component generates a second text representation and a second vector representation of a query pertaining to a designated target content. In some embodiments, the query processing component can generate the second vector representation of a query text using at least one of: machine learning model, a neural network, or an embedding-based method. These techniques convert textual data into a numerical format that can capture semantic meaning and contextual relationships between words, rather than relying on exact word matches. In various embodiments, the query processing component can generate a variable-length text representation of the second text representation and a fixed-length vector representation of the second vector representation based on runtime properties of a query text. By dynamically adapting text and vector representations at runtime, the system can ensure greater accuracy, flexibility, or efficiency in content attribution, even for queries of varying complexity.

In various embodiments, the matching component can match the second text representation and the second vector representation of the query against the first text representation and the first vector representation of the reference dataset using vector-based filtering and applies text-based similarity scoring to identify potential attribution against the designated target content. In some embodiments, the matching component can apply an adjustable similarity threshold to determine whether a match is exact, near exact, or reworded. This threshold can be adjustable, allowing the system to be fine-tuned based on the desired level of similarity sensitivity. According to some embodiments, the matching component can combine shingles of variable lengths with indexed text to improve an accuracy of similarity detection. The matching component can enhance similarity detection by employing shingling, a technique that breaks text into overlapping fragments of varying lengths, allowing the system to detect both exact phrase matches and paraphrased segments more effectively by aligning these shingles with indexed reference text for improved accuracy and efficiency in attribution assessment. In various embodiments, the matching component can apply a runtime-adjustable strictness parameter that allows variations in word order and text structure. The adjustable strictness can provide a customizable approach to similarity detection, making the system adaptable to various attribution and compliance requirements. In some embodiments, the matching component can perform the vector-based filtering before applying the text-based similarity scoring. This two-step approach can reduce computational overhead. According to various embodiments, the matching component can incorporate context-aware analysis by weighting different portions of the first text representation and the second text representation and the first vector representation and the second vector representation based on semantic importance. By prioritizing semantically important text, the system can enhance precision in identifying meaningful matches while reducing false positives from insignificant similarities.

In some embodiments, the system can further comprise a segmentation component that generates a shingle from a query text at runtime, wherein a shingle configuration is determined based on a use case and a text length.

Next, FIG. 4B illustrates a subprocess of method 400, denoted by “A” in FIG. 4A, that facilitates text attribution via similarity assessment in accordance with some embodiments described herein. While FIG. 4B is described relative to system 200 of FIG. 2, it can also be applicable to other systems described herein, such as system 100 of FIG. 1.

At 412, the method 400 includes applying an adjustable similarity threshold to determine whether a match is exact, near exact, or reworded. The method 400 can use a system operatively coupled to the processor (e.g., matching component 110) to apply an adjustable similarity threshold to determine whether a match is exact, near exact, or reworded.

At 414, the method 400 includes combining shingles of variable lengths with indexed text to improve an accuracy of similarity detection. The method 400 can use a system operatively coupled to the processor (e.g., matching component 110) to combine shingles of variable lengths with indexed text to improve an accuracy of similarity detection.

At 415, method 400 includes generating a shingle from a query text at runtime, wherein a shingle configuration is determined based on a use case and a text length. The method 400 can use a system operatively coupled to the processor (e.g., segmentation component 202) to dynamically determine the optimal shingle size and structure, ensuring greater flexibility in similarity detection across different content types and text lengths.

At 416, the method 400 includes applying a runtime-adjustable strictness parameter that allows variations in word order and text structure. The method 400 can use a system operatively coupled to the processor (e.g., matching component 110) to apply a runtime-adjustable strictness parameter that allows variations in word order and text structure.

At 418, the method 400 includes performing vector filtering before text-based similarity scoring. The method 400 can use a system operatively coupled to the processor (e.g., matching component 110) to perform vector filtering before text-based similarity scoring.

After step 418, the method returns to step 408 in FIG. 4A, where the second text representation and the second vector representation of the query are compared against the first text representation and the first vector representation of the reference dataset using vector-based filtering.

FIG. 4C illustrates a subprocess of method 400, denoted by “B” in FIG. 4A, that facilitates text attribution via similarity assessment in accordance with some embodiments described herein. While FIG. 4C is described relative to system 200 of FIG. 2, it can also be applicable to other systems described herein, such as system 100 of FIG. 1.

At 426, the method 400 includes incorporating context-aware analysis by weighting different portions of the first text representation and the second text representation and the first vector representation and the second vector representation based on semantic importance. The method 400 can use a system operatively coupled to the processor (e.g., matching component 110) to incorporate context-aware analysis by weighting different portions of the first text representation and the second text representation and the first vector representation and the second vector representation based on semantic importance. In 426, the system can assign higher weights to key phrases, improving the accuracy of attribution detection.

At 428, the method 400 includes generating a variable-length text representation of the second text representation and a fixed-length vector representation of the second vector representation based on runtime properties of a query text. The method 400 can use a system operatively coupled to the processor (e.g., query processing component 106) to generate a variable-length text representation of the second text representation and a fixed-length vector representation of the second vector representation based on runtime properties of a query text.

At 430, the method 400 includes generating the second vector representation of a query text using at least one of: machine learning model, a neural network, or an embedding-based method. The method 400 can use a system operatively coupled to the processor (e.g., query processing component 106) to generate the second vector representation of a query text using at least one of: machine learning model, a neural network, or an embedding-based method.

After 430, the method returns to step 406 in FIG. 4A, where a second text representation and a second vector representation of a query pertaining to a designated target content are generated.

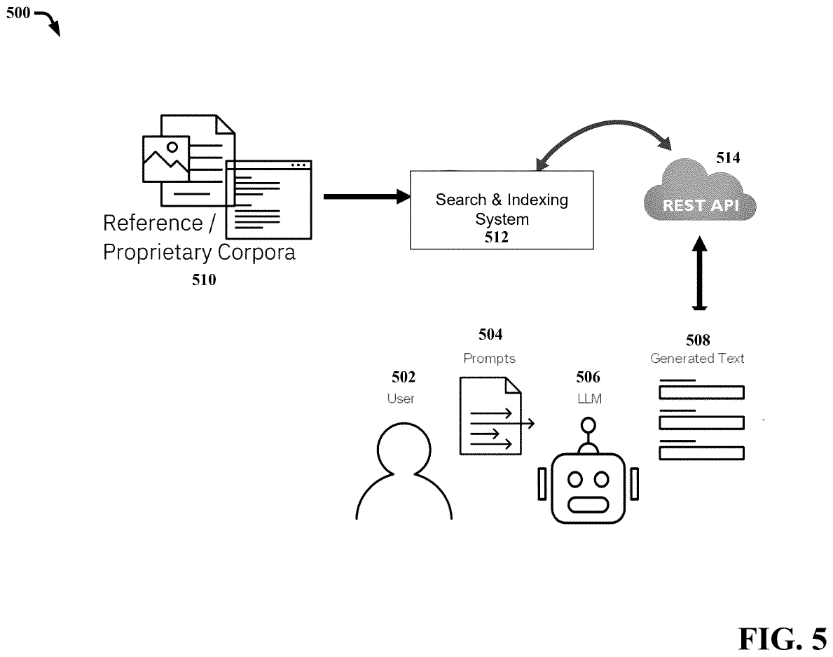

FIG. 5 illustrates an example overview of an indexed reference dataset and similarity assessment process, which facilitates efficient and scalable content attribution in accordance with some of the embodiments described herein. The disclosed system introduces an external data store containing a reference corpus that is indexed and can be utilized for similarity assessment.

The system operates under the assumption that a reference dataset must be in possession of an entity performing a similarity assessment. This can be critical in contexts such as copyright verification and confidential data protection, where only a finite, known set of reference content is relevant for attribution. For example, in copyright enforcement, a publisher may maintain a defined set of proprietary works for comparison, rather than relying on a universal dataset. Similarly, for company-confidential information, a dynamic and evolving reference corpus may be maintained, incorporating internal data from sources such as messages, emails, or company documents, with automatic expiration policies to ensure real-time relevance.

Reference/Proprietary corpus (510) can be indexed using two parallel methods: free-text indexing for lexical similarity and vector indexing for semantic similarity. This dual approach allows the search & indexing system (512) to provide more accurate and flexible retrieval than other methods. Unlike static chunking approaches, this method can enable dynamic and adaptive retrieval, improving recall accuracy by allowing the system to analyze entire documents or smaller text segments as needed.

A query is initiated by a user (502) via a prompt (504), which is processed by a large language model (LLM) (506) to generate text (generated text 508). The system then can perform a two-stage retrieval process through the REST API (514). First, the query undergoes vector-based filtering, which enables broad recall of semantically similar matches based on contextual relevance. After a set of candidate matches is identified, a text-based similarity scoring operation refines attribution by comparing textual features. This two-step retrieval process can optimize computational efficiency by leveraging vector-based recall before engaging in more resource-intensive lexical similarity assessments, effectively reducing computational burden of full-text comparisons.

Since lexical similarity operations are computationally expensive compared to vector-based filtering, the system can prioritize vector-based queries first, reducing a dataset scope before performing text-based similarity scoring. This structured query optimization ensures that the system remains scalable, even when dealing with large datasets or high-frequency similarity assessments.

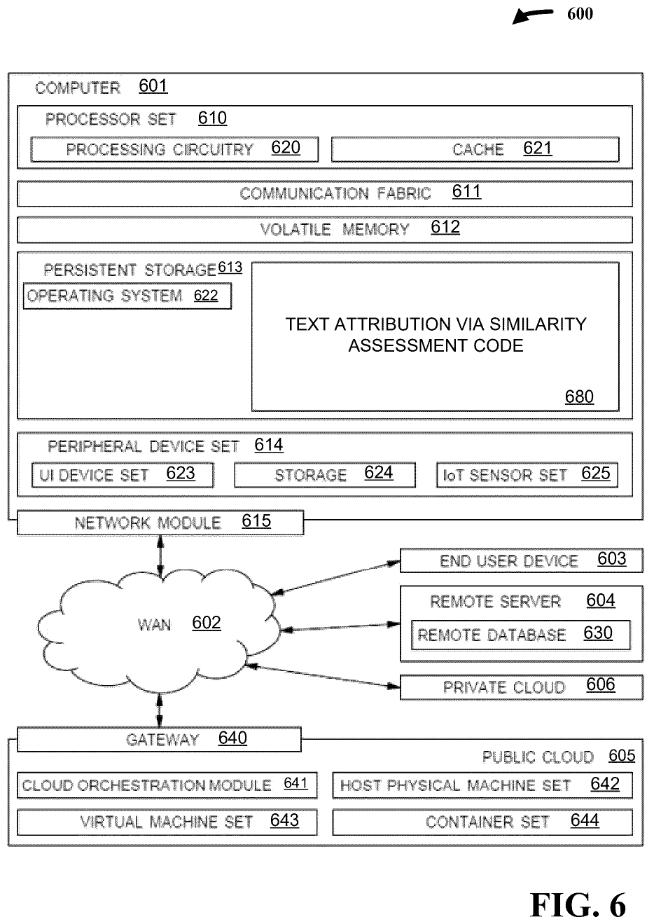

FIG. 6 and the following discussion are intended to provide a brief, general description of a suitable computing environment 600 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as text attribution via similarity assessment code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 680 as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method can be distributed among multiple computers and/or between multiple locations. On the other hand, in this presentation of computing environment 600, detailed discussion is focused on a single computer, specifically computer 601, to keep the presentation as simple as possible. Computer 601 can be located in a cloud, even though it is not shown in a cloud in FIG. 6. On the other hand, computer 601 is not required to be in a cloud except to any extent as can be affirmatively indicated.

PROCESSOR SET 610 includes one, or more, computer processors of any type now known or to be developed in the future. Processing circuitry 620 can be distributed over multiple packages, for example, multiple, coordinated integrated circuit chips. Processing circuitry 620 can implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set can be located “off chip.” In some computing environments, processor set 610 can be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods can be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths can be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory can be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 can be a read only memory (ROM), but typically at least a portion of the persistent storage allows writing of data, deletion of data and re-writing of data. Some familiar forms of persistent storage include magnetic disks and solid-state storage devices. Operating system 622 can take several forms, such as various known proprietary operating systems or open-source Portable Operating System Interface type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 can include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 can be persistent and/or volatile. In some embodiments, storage 624 can take the form of a quantum computing storage device for storing data in the form of qubits. In embodiments where computer 601 is required to have a large amount of storage (for example, where computer 601 locally stores and manages a large database) then this storage can be provided by peripheral storage devices designed for storing large amounts of data, such as a storage area network (SAN) that is shared by multiple, geographically distributed computers. IoT sensor set 625 is made up of sensors that can be used in Internet of Things applications. For example, one sensor can be a thermometer, and another sensor can be a motion detector.

NETWORK MODULE 615 is the collection of computer software, hardware, and firmware that allows computer 601 to communicate with other computers through WAN 602. Network module 615 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and can take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 can be a client device, such as thin client, heavy client, mainframe computer and/or desktop computer.

REMOTE SERVER 604 is any computer system that serves at least some data and/or functionality to computer 601. Remote server 604 can be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data can be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs can be stored as images and can be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware and firmware allowing public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an indexing component that generates and stores a first text representation and a first vector representation of a reference dataset;
a query processing component that generates a second text representation and a second vector representation of a query pertaining to a designated target content; and
a matching component that matches the second text representation and the second vector representation of the query against the first text representation and the first vector representation of the reference dataset using vector-based filtering and applies text-based similarity scoring to identify potential attribution against the designated target content.

2. The system of claim 1, wherein the indexing component stores the first text representation and the first vector representation together in a structured index to improve retrieval efficiency.

3. The system of claim 1, wherein the query processing component generates the second vector representation of a query text using at least one of: machine learning model, a neural network, or an embedding-based method.

4. The system of claim 1, wherein the query processing component generates a variable-length text representation of the second text representation and a fixed-length vector representation of the second vector representation based on runtime properties of a query text.

5. The system of claim 1, wherein the matching component applies an adjustable similarity threshold to determine whether a match is exact, near exact, or reworded.

6. The system of claim 1, wherein the matching component combines shingles of variable lengths with indexed text to improve an accuracy of similarity detection.

7. The system of claim 1, wherein the matching component applies a runtime-adjustable strictness parameter that allows variations in word order and text structure.

8. The system of claim 1, wherein the matching component performs the vector-based filtering before applying the text-based similarity scoring.

9. The system of claim 1, wherein the matching component incorporates context-aware analysis by weighting different portions of the first text representation and the second text representation and the first vector representation and the second vector representation based on semantic importance.

10. The system of claim 1, further comprises a segmentation component that generates a shingle from a query text at runtime, wherein a shingle configuration is determined based on a use case and a text length.

11. A computer-implemented method that utilizes a processor that executes computer executable components stored in memory to perform the following acts:
generating and storing a first text representation and a first vector representation of a reference dataset;
generating a second text representation and a second vector representation of a query pertaining to a designated target content;
matching the second text representation and the second vector representation of the query against the first text representation and the first vector representation of the reference dataset using vector-based filtering; and
applying text-based similarity scoring to identify potential attribution against the designated target content.

12. The method of claim 11, further comprising storing the first text representation and the first vector representation together in a structured index to improve retrieval efficiency.

13. The method of claim 11, further comprising generating the second vector representation of a query text using at least one of: machine learning model, a neural network, or an embedding-based method.

14. The method of claim 11, further comprising generating a variable-length text representation of the second text representation and a fixed-length vector representation of the second vector representation based on runtime properties of a query text.

15. The method of claim 11, further comprising applying an adjustable similarity threshold to determine whether a match is exact, near exact, or reworded.

16. The method of claim 11, further comprising combining shingles of variable lengths with indexed text to improve an accuracy of similarity detection.

17. The method of claim 11, further comprising applying a runtime-adjustable strictness parameter that allows variations in word order and text structure.

18. The method of claim 11, further comprising performing the vector-based filtering before applying the text-based similarity scoring.

19. The method of claim 11, further comprising incorporating context-aware analysis by weighting different portions of the first text representation and the second text representation and the first vector representation and the second vector representation based on semantic importance.

20. A computer program product comprising a computer readable storage medium having program instructions embodied therewith, the program instructions executable by a processor to cause the processor to:
generate and store a first text representation and a first vector representation of a reference dataset;
generate a second text representation and a second vector representation of a query pertaining to a designated target content;
match the second text representation and the second vector representation of the query against the first text representation and the first vector representation of the reference dataset using vector-based filtering; and
apply text-based similarity scoring to identify potential attribution against the designated target content.
